(19) United States
(12) Patent Application Publication
(10) Pub. No.: US 2016/0132907 A1
(43) Pub. Date: May 12, 2016

(54) METHODS, SYSTEMS, AND APPARATUS FOR DATA FORECASTING

(71) Applicants: Laura DiTomasso, Lakeway, TX (US); Adam Thier, Pleasanton, CA (US); Monica Bhat, Pleasanton, CA (US); Matthew Harrison, Macclesfield (GB)

(72) Inventors: Laura DiTomasso, Lakeway, TX (US); Adam Thier, Pleasanton, CA (US); Monica Bhat, Pleasanton, CA (US); Matthew Harrison, Macclesfield (GB)

(21) Appl. No.: 14/535,621

(22) Filed: Nov. 7, 2014

(51) Int. Cl. G06Q 30/02

(52) U.S. Cl. CPC G06Q 30/0202

(57) ABSTRACT

Methods, systems, and computer program products for generating a business forecast are described. A specification of a precision level of a forecast is obtained. Data that satisfies the specified precision level of the forecast is identified and a forecast based on the identified data that satisfies the specified precision level of the forecast is generated.

### FIELD

The present disclosure relates, generally, to data forecasting. In an example embodiment, the disclosure relates to forecasting business metrics, such as revenue and cash-on-hand.

### BACKGROUND

Forecasting various business metrics is paramount to managing businesses of all sizes. The business forecasts are often performed based on historic information and ad-hoc knowledge of current business activities. Business forecasts are often performed in a static manner, but maintaining up-to-date business forecasts is an important aspect of managing a business.

### BRIEF DESCRIPTION OF DRAWINGS

The present disclosure is illustrated by way of example and not limitation in the figures of the accompanying drawings, in which like references indicate similar elements and in which:

FIGS. 1A and 1B illustrate schematic diagrams of example systems for forecasting business metrics, in accordance with an example embodiment;

FIG. 2 is a high-level block diagram of a system for forecasting business metrics, in accordance with an example embodiment;

FIG. 3 is a low-level block diagram of a system for forecasting business metrics, in accordance with an example embodiment;

FIG. 4 is a block diagram of an example apparatus for forecasting business metrics, in accordance with an example embodiment;

FIG. 5 is a representation of an example user interface for a user home page, in accordance with an example embodiment;

FIG. 6 is a representation of an example user interface for scheduling appointments in an online calendar, in accordance with an example embodiment;

FIG. 7 is a representation of an example user interface for accessing a time sheet, in accordance with an example embodiment;

FIG. 8 is a representation of an example user interface for modifying a time sheet, in accordance with an example embodiment;

FIG. 9 is a representation of an example user interface for viewing a revenue forecast, in accordance with an example embodiment;

FIG. 10 is a representation of an example user interface for accessing a contract status, in accordance with an example embodiment;

FIG. 11 is a representation of an example user interface for accessing details of a revenue forecast, in accordance with an example embodiment;

FIG. 12 is a representation of an example user interface for accessing details of a utilization for a plurality of consultants, in accordance with an example embodiment;

FIG. 13 is a representation of the example user interface of FIG. 12 overlaid with a consultant pop-up window, in accordance with an example embodiment;

FIG. 14 is a flowchart for an example workflow for generating a business forecast, in accordance with an example embodiment;

FIG. 15 is a flowchart for an example method for generating a time sheet from calendar entries, in accordance with an example embodiment;

FIGS. 16A and 16B are flowcharts for example methods for generating a forecast, in accordance with an example embodiment;

FIG. 17 is a flowchart for an example method for generating a forecast, in accordance with an example embodiment;

FIG. 18 is a block diagram illustrating an example mobile device, according to an example embodiment and

FIG. 19 is a block diagram of a computer processing system within which a set of instructions may be executed for causing the computer to perform any one or more of the methodologies discussed herein.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for forecasting business metrics, such as revenue and cash-on-hand, are disclosed. In one example embodiment, a framework and architecture of software modules called TEAM (Time and Expense Accounting System) built around a cloud infrastructure provides a high-performance, real-time mechanism to forecast business metrics. For example, projected cash transactions can be automatically predicted to generate a cash forecast. The cash forecast may have a determined level of precision, as described more fully below. The precision may be based on a source(s) of the data used to generate the forecast. For example, in a consulting business where an employee's time is billed to a client on an hourly basis, a forecast may be generated based on scheduled work events, time sheets, and invoices. A forecast based on a scheduled work event of an employee for a work item (such as a scheduled business meeting), however, may have a low precision while a forecast based on an invoice for the employee's services may have a high precision. As work events are completed, the forecast may be updated to increase the precision. In one example embodiment, the forecast is generated dynamically and may be updated after each event that may impact the forecast. In one example embodiment, the forecast is generated and/or updated periodically or at a predefined time.

The described forecasting technology may be useful in a variety of industries, including the services industry and high-tech industries, and may be used to, for example, manage cash to ensure business viability and to, for example, track cash for the planning of future investments. Benefits may include an accurate representation of future cash positions, a removal of latency and promotion of visibility of cash-related transactions, a removal of redundant manual inputs across multiple systems, and real-time analytics based on a level of precision.

In one example embodiment, a variety of business metrics may be forecast. For example, most businesses run on cash; thus, cash-on-hand is a key aspect of financial management that may be forecast. Cash inflow and outflow may be monitored on a daily basis to forecast the cash-on-hand. A typical example is the services industry, where the “time is money” concept is important since customers are billed based on services provided, often in terms of number of hours worked. Forecasting based on the booking of customer engagements may help the business to determine the potential inflow of cash and the potential expenses which may require an outflow of cash related to the services provided. In conventional systems, forecasts may be based on historic data and an ad-hoc knowledge of the current business activities; such forecasts may not, however, be based on an accurate representation of current business activities.

In one example embodiment, the forecast may start from a foundation of planned events. For example, in a consulting service where services are billed at an hourly rate, a forecast with a low level of accuracy may be generated at a time of contract based on the terms of the contract. The contractual events defined in the contract, such as defined work items, may result in a preliminary (low precision) estimate of potential revenue for the firm. As work on the contract progresses, the forecast may be updated and may become more precise. The forecasting may be automatically updated during the life of the contract, during a specified time period, periodically, and/or in response to an event.

As work events are scheduled, the forecast based on the contract may be revised to produce a forecast with a higher level of precision. For example, the scheduling of a specification review meeting may be indicative of both a status of a work item (i.e., a specification is ready for review) and the revenue to be generated by the employee's time attending the review meeting. Thus, the forecast can be revised to account for the revenue expected as a result of the meeting. As invoices are generated and payments are received, the forecast may be similarly revised to have a higher level of precision.

Initially, the precision level of the forecast may be low, such as when a customer schedules a date to engage for service. Dates and times may change right up to the point of fulfilling the event. Once the event has passed and the work/service is complete, the forecast may be revised and may become more precise. However, there are still adjustments that may change the expected inflow or outflow of cash. For example, a time sheet and corresponding invoice may need to be generated, reviewed, and modified.

Once a business determines an accurate representation of services shown on a pro forma basis (including, for example, time, expense and other adjustments) based on agreed guidelines, an invoice may be generated. At this point, the business may be able to generate a cash forecast and/or revenue forecast with a higher level of precision. A business owner, however, may need not only an accurate and reliable cash forecast in substantially real-time, but also may need to know how precise that forecast is in order to make optimal business decisions.

Once a business receives payment on an invoice, the amount represented in the forecast may become more precise. The forecast may be updated as a rolling forecast, i.e., the forecast may take into account the actual realization of cash. As the actual cash inflow and outflow is determined, cash forecasts for future time periods may be revised accordingly. The final payment of the invoice may lead to the highest precision forecast. Once all payments are received, the actual cash transaction is completed and the forecast may reach its highest level of accuracy.

In some example embodiments, the forecasting may be performed in substantially real-time based on planned and realized calendar events, real-time cash realization, and a real-time classification of inflow and outflow of cash based on a text analysis of an event (e.g., expenses incurred vs. billed hours).

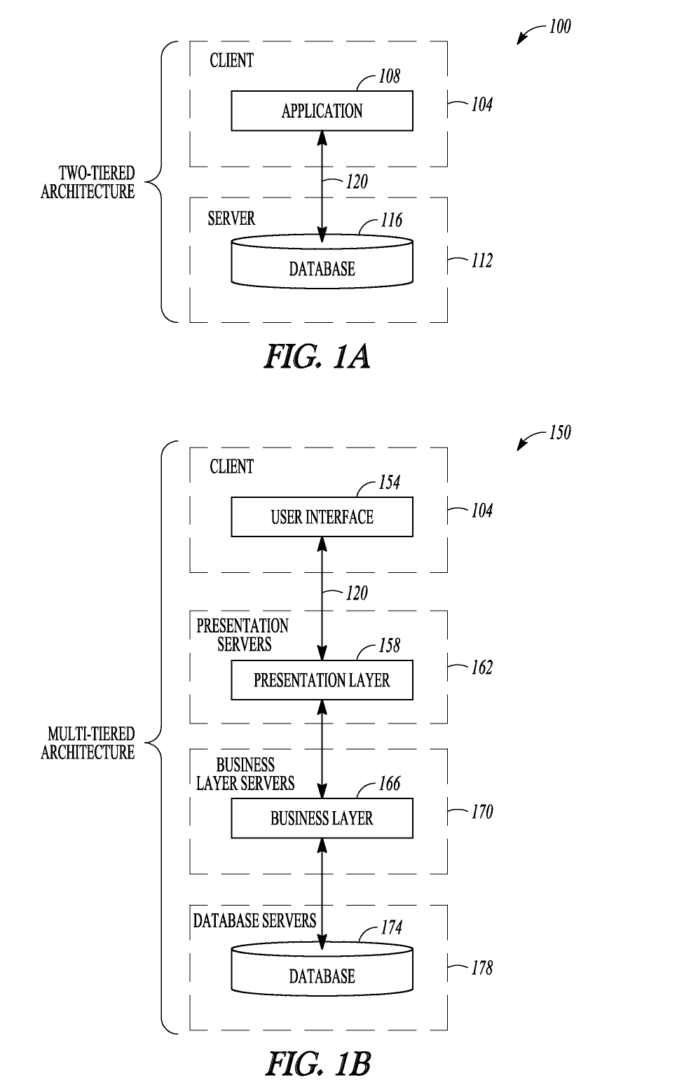

FIGS. 1A and 1B illustrate schematic diagrams of example systems for forecasting business metrics, in accordance with an example embodiment. Traditional client-server systems may employ a two-tiered architecture such as that illustrated by system 100 in FIG. 1A. Application 108 executed on the client device 104 of the two-tiered architecture may be comprised of a monolithic set of program code including a graphical user interface component, presentation logic, business logic and a network interface that enables the client device 104 to communicate over a network 120 with one or more servers 112. A database 116 may be maintained on the server 112 that provides non-volatile or “persistent” storage for the data accessed and/or processed by the application 108.

The “business logic” component of the application 108 may represent the core program code of the application 108, i.e., the rules governing the underlying business process (or other functionality) provided by the application 108. The “presentation logic” may describe the specific manner in which the results of the business logic are formatted for display on the user interface. The “database” 116 may include data access logic used by the business logic to store and retrieve data.

In response to limitations associated with the two-tiered client-server architecture, a multi-tiered architecture has been developed, as illustrated in FIG. 1B. In the multi-tiered system 150, the presentation layer 158, business layer 166 and database 174 may be logically separated from the user interface 154 of the application 108. These layers may be moved off of the client device 104 to one or more dedicated servers on the network 120. For example, the presentation layer 158, the business layer 166, and the database 174 may each be maintained on separate servers (e.g., presentation servers 162, business layer servers 170 and database servers 178).

This separation of logical components and the user interface 154 may provide a more flexible and scalable architecture compared to that provided by the two-tiered model of the system 100 in FIG. 1A. For example, the separation may ensure that all clients share a single implementation of business layer 166. If business rules change, changing the current implementation of business layer 166 to a new version may not call for updating any client-side program code. In addition, the presentation layer 158 may be provided, which generates code for a variety of different user interfaces 154, which may be standard browsers.

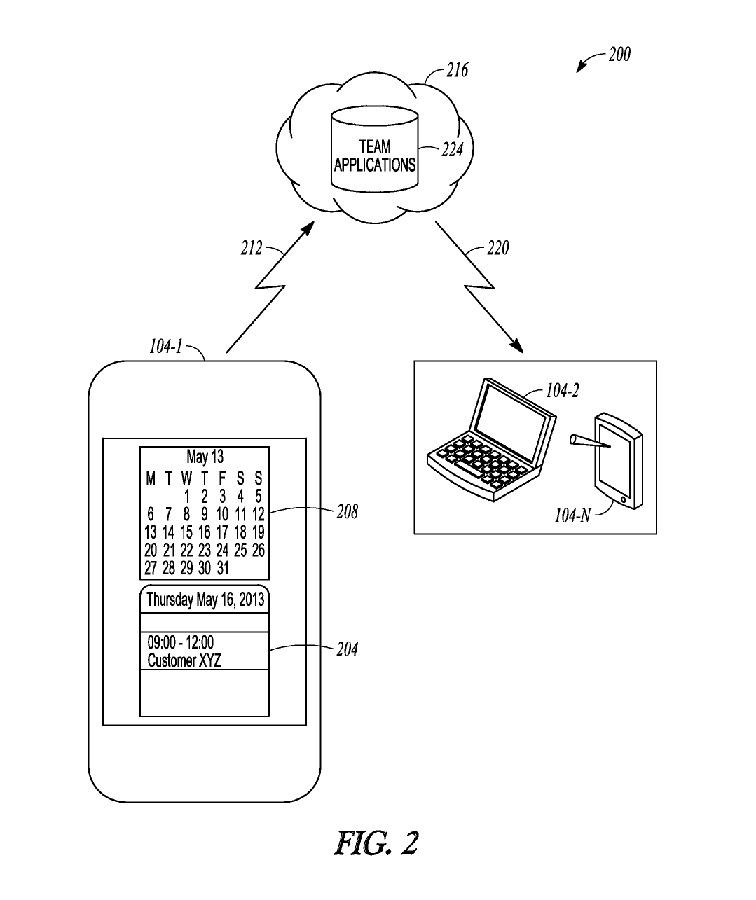

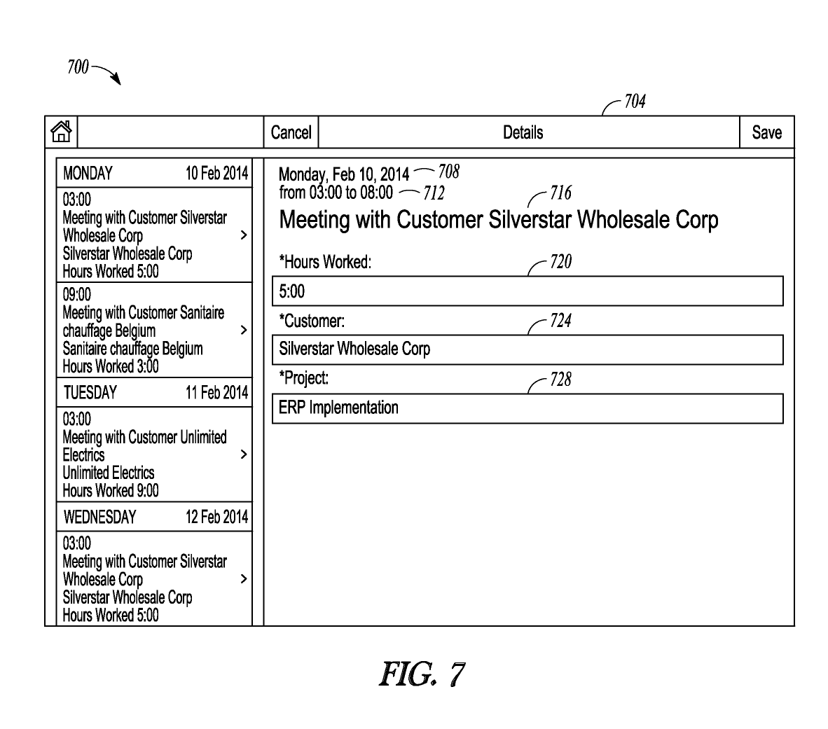

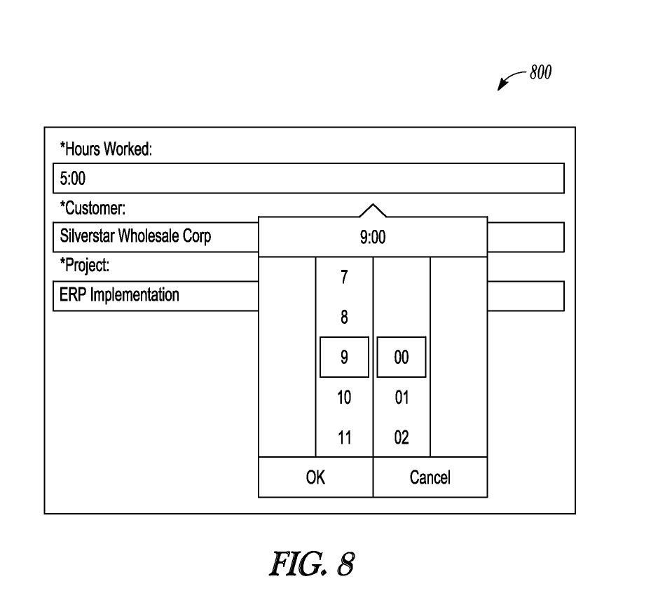

FIG. 2 is a high-level block diagram of a system 200 for forecasting business metrics, in accordance with an example embodiment. In one example embodiment, client devices 104-1, . . . , 104-N (hereinafter client devices 104) may enable a user to, for example, schedule an appointment 204 in an online calendar 208 or view a forecast. The client devices 104 may be a personal computer (PC), a tablet computer, a mobile phone, a personal digital assistant (PDA), a wearable computing device (e.g., a smartwatch), or any other appropriate computer devices. Each client device (104-1, 104-2 or 104-N) may include a user interface module, described more fully below in conjunction with, for example, FIGS. 7 and 8. In one embodiment, the user interface module may include a web browser program and/or an application, such as a mobile application. Although a detailed description is only illustrated for client device 104-1, it is noted that each of the other client devices may have corresponding elements with the same functionality.

A network connection 212 may provide communication between the client device 104-1 and a cloud infrastructure 216. Similarly, a network connection 220 may provide communication between client devices 104-2, 104-N and the cloud infrastructure 216. The network connection 212 may be may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks.

The cloud infrastructure 216 may comprise a server, client, or other processing device that includes an operating system for executing software instructions and TEAM applications 224. The TEAM applications 224 are designed to generate one or more forecasts for various business metrics and may default to an automatic calculated precision of the forecast based on the natural workflow, as described more fully below. The cloud infrastructure 216 may allow a user to customize how the precision of the forecast(s) is to be calculated. Options, such as setting a percentage threshold, a day threshold, or other factor based on, for example, the event and the terms of the contract, may be included. The precision level may be configurable and may be based on the amount percentage, count of days outstanding, or other metrics defined by the user(s). These metrics may be configured at the contract level, the organizational level, the global level, and the like. The precision threshold defined for one level may override the metrics at another level. For example, the precision threshold defined for the contract level may override the metrics at the organizational level. These thresholds introduce a variety of scenarios enabling the customer to set the way the precision may be calculated based on their unique business environment.

In one example embodiment, the time period during which a user's calendar is analyzed and/or synchronized may be based on a day count threshold, i.e., the user's calendar may be analyzed and/or synchronized after a defined number of days. An alert mechanism may alert the appropriate users and/or resources of changes to, for example, a calendar entry in the situation where the original calendar entry has already been processed or is being processed. For example, if a meeting is canceled or a length of time of a meeting in a prior week is changed after the specified time period, the meeting calendar entry may require an alternative process to generate an adjusted invoice, issue a credit and/or charge additional fees since the meeting calendar entry has been changed.

There may also be a loop between the contract and the time charges and expenses. For example, a validation of the time charges and expenses may be performed to ensure that the appropriate billing rates and the appropriate expense limits, as defined in the contract, are adhered to.

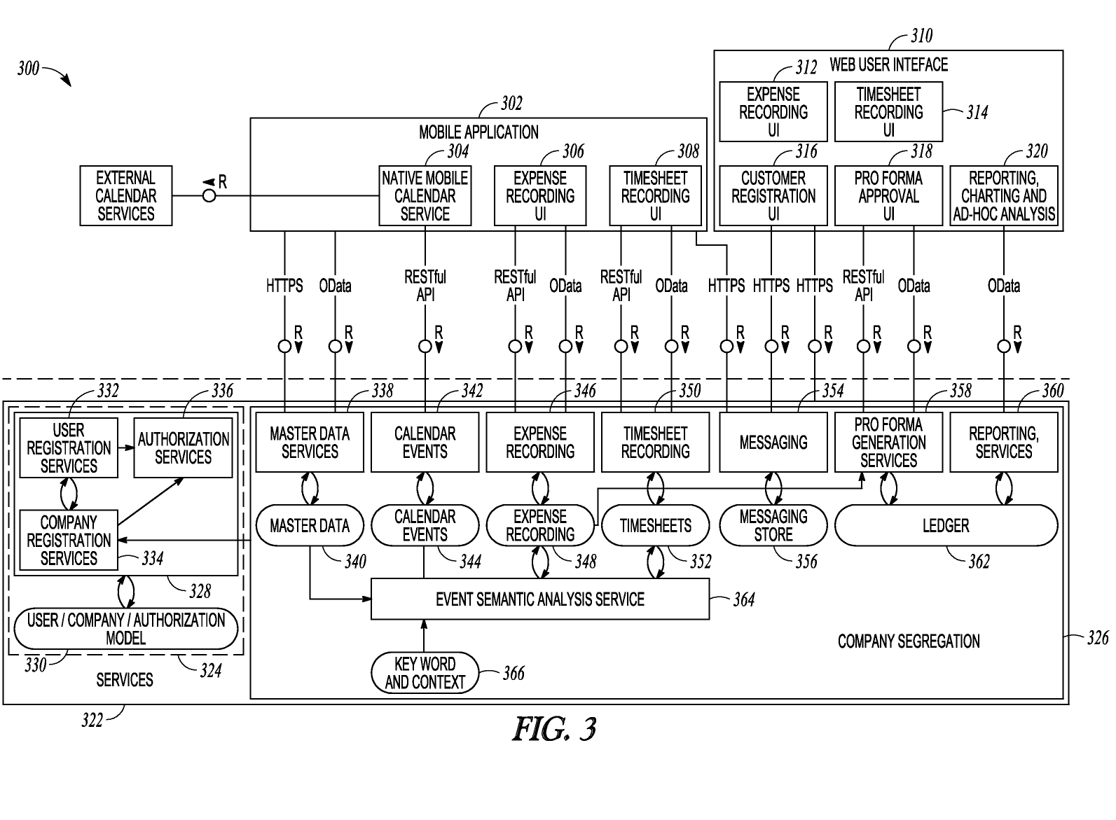

FIG. 3 is a low-level block diagram of a forecasting system 300 for forecasting business metrics, in accordance with an example embodiment. In one example embodiment, a mobile application 302 and/or a web user interface 310 may execute on, for example, the client device 104-1 and may provide a user with access to the forecasting system 300 executing on the cloud infrastructure 216.

The mobile application 302 may comprise a native mobile calendar service 304, an expense recording user interface 306, and a time sheet recording user interface 308. The web user interface 310 may comprise an expense recording user interface 312, a time sheet recording user interface 314, a customer registration user interface 316, a pro forma approval user interface 318, and a reporting, charting, and ad-hoc analysis module 320. The native mobile calendar service 304 may enable a user to schedule meetings and other work tasks in an online calendar. The expense recording user interface 306 and the expense recording user interface 312 may enable a user to record and submit expenses, such as travel expenses, to an expense recording service 346. The time sheet recording user interface 308 and the time sheet recording user interface 314 may enable a user to record and submit time sheets to a time sheet recording service 350. The customer registration user interface 316 may enable a customer to register with, for example, a messaging service 354 to leave messages for users of the forecasting system 300. The pro forma approval user interface 318 may enable a user to review, modify, and/or approve a time sheet and/or an invoice. The reporting, charting, and ad-hoc analysis module 320 may, for example, enable a user to request the generation of a forecast of a business metric for a specified time period.

The forecasting system 300 may comprise a services layer 322 that may include a registration and authorization component 324 and a services component 326 for each customer of the business.

The registration and authorization component 324 may comprise registration and authorization services 328 based on a user/company/authorization model 330. The registration and authorization services 328 may include user registration services 332, company registration services 334, and authorization services 336. The registration and authorization component 324 may authenticate and/or authorize a user to access the forecasting system 300. The authorization may be required to schedule calendar entries, generate a time sheet or invoice, approve a time sheet or invoice, and/or request the generation of a forecast.

The services component 326 may comprise a master data service 338 and a master data storage element 340; a calendar event service 342 and a calendar event storage element 344; the expense recording service 346 and an expense recording storage element 348; the time sheet recording service 350 and a time sheet storage element 352; the messaging service 354 and a messaging storage element 356; and a pro forma generation service 358, a reporting service 360, and a ledger storage element 362. In addition, the services component 326 may comprise an event semantic analysis service 364 and a key word and context storage element 366.

The master data service 338 and master data storage element 340 may provide an ability to create master data based on a semantic analysis of a calendar and may store the master data for subsequent use. The pro-forma generation service 358 may provide the ability to generate pro-forma financial results for hypothetical scenarios. The reporting service 360 and the ledger storage element 362 may provide the ability to create and store data for analytic purposes and financial reporting.

Semantics and machine learning may be applied in determining the amount, timing and appropriate line item for the forecast. Metadata may be abstracted from, for example, a contract to project, for example, a potential invoice payment and/or the amount to be billed based on the association of the resource, customer contract, and work performed.

The calendar events service 342 and the calendar events storage element 344 may maintain a calendar(s) that mirrors a local calendar of a user maintained on, for example, the client device 104-1.

The expense recording service 346 and the expense recording storage element 348 may record and maintain expenses submitted by users, and may allow users to review, modify, and approve the expenses. The time sheet recording service 350 and the time sheet storage element 352 may record and maintain time sheets submitted by users, and may allow users to review, modify, and approve the time sheets.

The messaging service 354 and a messaging storage element 356 may allow users and customers to exchange messages, and may provide messages to users and customers regarding the status of forecasts.

The event semantic analysis service 364 and the key word and context storage element 366 may assist in parsing calendar entries to identify scheduled work tasks that are to be considered in a forecast and/or to assist in identifying scheduled work tasks to be included in an automatically-generated time sheet.

In one example embodiment, a revenue forecast may be generated by extracting billing information from a user's calendar. For example, a user may schedule future consulting services in an online calendar. The forecasting system 300 may scan the online user's calendar to identify the scheduled work events and, based on the identified work events, the forecasting system 300 may generate a forecast for, for example, revenue and/or cash-on-hand.

In one example embodiment, the user may enter a calendar event for a customer and/or project work item; the calendar event may contain an estimated duration of the work event. The forecasting system 300 may maintain the fees that this specific user will be charging the customer for their work, such as an hourly rate. The forecasting system 300 may compute an amount of revenue associated with the work event by multiplying the estimated duration of the work event by the hourly rate. The computed amount of revenue may become the baseline of a forecast with, for example, a precision level 1. Since the work has not occurred, the schedule of the work may be easily changed.

In one example embodiment, such calendar events may create transactions which may be used to generate and/or revise a forecast. The calendar events/transactions may include (in precision order):
a. Scheduled hours: may result in a revenue forecast (may be computed for the scheduled time frame and cash based on contract terms);
b. Completed work hours: may result, for example, in revenue to be collected from a customer, payment to a contractor, and a calculation of a bonus to an employee;
c. Work hours approved: may result in generation of an invoice;
d. Expenses incurred: may result, for example, in charge backs to be collected from a customer and expense reimbursements to an employee and/or contractor;
e. Expenses approved: may result in a generation of an invoice and payment(s)/reimbursement(s);
f. Invoice adjustments: may result in a revision of the revenue projected based on the approved work hours;
g. Issuance of invoices: may result in calculating the expected revenue based on the contract terms; and
h. Collection of payment on invoices: may result in a determination of a finalized revenue number.

Each of the above may have a corresponding impact(s) on business forecasts, such as revenue and cash-on-hand, based on the rules of payment (e.g., terms of a contract). The forecasting system 300 may understand or determine that the work has been completed and may therefore create a pro forma invoice. Based on the initial calculation of duration, fee, and expenses, the forecast may be updated in terms of the inflow and outflow of cash. The updating may be based on a projected time of issuing an invoice and a projected time of receiving payment. For example, the forecasting system 300 may be configured to issue an invoice at the end of the month with a 30-day due date, and the 30-day due date may be used as an approximate timeframe for receiving a payment from the client. In one example embodiment, the issuance of invoices and/or reception of payments from each customer may be tracked and characterized, and the characterization may be used in a projection. For example, a reception of payments from a particular customer may be tracked and the amount of time between issuing an invoice and receiving payment may be characterized, and the characterization may be used to forecast receipt of a payment and to revise a revenue forecast accordingly. The precision of the forecast may now be more accurate and may be tagged as, for example, precision level 2.

The user may submit pro forma invoices and/or time sheets for review by a manager or billing specialist. The pro forma submissions may be adjusted to reflect different terms from the standards, to add or reduce charges, or make changes in the terms. Once the manager has approved the pro forma submissions, the forecasting system 300 may update the forecast with the changes and the level of the forecast may increase to, for example, precision level 3. Even if no changes are made, the precision level may be raised because the review and approval of the pro forma submissions has been completed.

Once a portion or all of the work has been reviewed for the customer project, a bill/invoice may be generated. The customer may have outstanding credits that may be applied to the invoice or may have pre-paid a portion of the invoice. At this time, the revenue and/or cash-on-hand forecasts may be revised. Also, once the invoice is ready to be submitted to the customer, the precision of the forecast may reach a higher level, such as precision level 4.

At the time of payment, cash is realized and the revenue is no longer a forecasted number. However, in the case of a rolling forecast, the precision may be raised to, for example, the level of 5, which may be the highest level, to indicate that the revenue has been realized. The forecast may be adjusted to reflect the current cash balance and the remaining forecasted values.

In one example embodiment, a level of precision of a forecast may be selected by a user. For example, a manager may request the generation of a forecast that meets a specified precision level. Selecting a precision level of zero (0) will generate a forecast that contains forecasts of all precision levels and may provide a big picture of what can be expected based on known events, as the forecast will include estimates at all stages of the contract process.

A forecast may also be generated that excludes the estimates having lower precision values. This may provide a more precise forecast since more of the forecast risk is removed from the forecast. In one example embodiment, selecting a value higher than zero (0) will exclude all precision values that are less than the selected value from the forecast. For example, a selection of a precision of two (2) in the scenario above means that values marked with precision zero (0) and one (1) will be excluded from the forecast. In the latter case, a business can be more certain that the revenue or cash indicated in the forecast will be realized, although the forecast may be based on fewer business metrics than a forecast with a lower level of precision.

In one example embodiment, the forecasting system 300 may determine how precise the forecast is at any given point in time. Forecasted items may also be removed from a forecast when the cash is realized and may be replaced with the forecasted item's final cash value.

In one example embodiment, a procurement of goods may create various transactions which may be used to generate and/or revise a forecast. For example, the procurement of goods/transactions may include:

a. Placement of an order;

b. Approval of the order;

c. Acceptance of the order by the supplier;

d. Receipt of goods; and

e. Payment of goods.

The payment of goods may finalize the outflow of cash; similar to the inflow of cash from receiving payment for an invoice, the outflow of cash associated with the paid goods may no longer be forecasted values. Each of the above activities may generate a transaction and change the precision of the forecast for a given transaction.

In one example embodiment, payroll and other regular outflows, such as rent and maintenance contracts, may be used to forecast, for example, cash-in-hand. Payroll may be determined based on current resources and may reflect a forecast of the use of cash and expense to the business. Associated payroll taxes and expenses may also be forecasted. New employees and/or contractors may be forecasted based on an initial offer or contract.

In one example embodiment, other inflows of cash, additional revenue sources, and/or interest on investments may also trigger the generation or revision of an associated forecast. The precision of the forecast may change as a transaction progresses from inception to completion.

In one example embodiment, the forecasting system 300 may be designed to learn (e.g., designed as an organic process) and, therefore, the precision may be increased as the knowledge of the forecasting system 300 increases. In one example embodiment, behaviors of customers and suppliers may be tracked and their behavior may be characterized. The characterizations may be used to generate and/or revise a forecast. For example, if a customer contracts to pay in 30 days, but typically pays in 10 days, the forecast can learn this behavior and adjust the forecast accordingly.

Customers may have the ability to enter values into the forecast. For example, a customer may choose to override a forecast or one or more components of a forecast. If the data needed by the forecasting system 300 to derive a component of the forecast is not available or the forecasting system 300 is not designed to determine a particular component of the forecast, a customer may have the ability to enter the corresponding value(s). The forecasting system 300 may provide an indication as to the origin, adjustments to, and precision of one or more components of the forecast, and may provide full transparency on the audit trail.

In one example embodiment, native natural language processes are used to evaluate data input and define a forecast. The forecast may be computed in real-time based on real-time changes, such as transactions and the occurrence of calendar events.

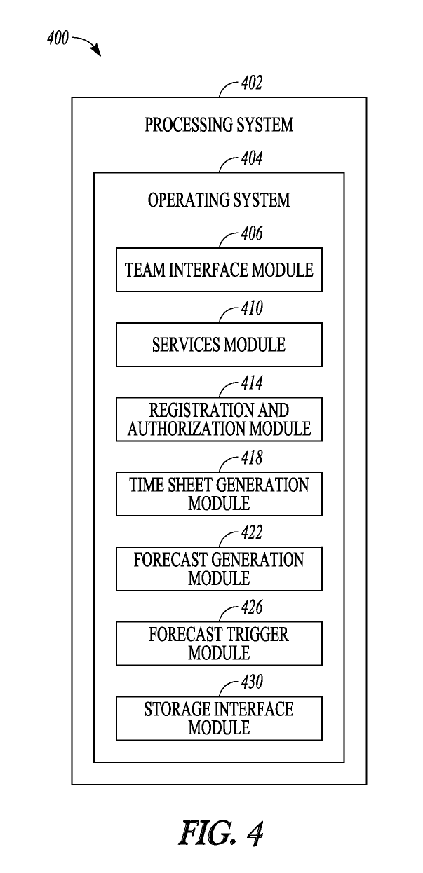

FIG. 4 is a block diagram of an example apparatus 400 for forecasting business metrics, in accordance with an example embodiment. For example, the apparatus 400 may be used to generate a business forecast.

The apparatus 400 is shown to include a processing system 402 that may be implemented on a server, client, or other processing device that includes an operating system 404 for executing software instructions. In accordance with an example embodiment, the apparatus 400 may include a TEAM interface module 406, a services module 410, a registration and authorization module 414, a time sheet generation module 418, a forecast generation module 422, a forecast trigger module 426, and a storage interface module 430.

The TEAM interface module 406 and services module 410 may enable the time sheet generation module 418, the forecast generation module 422, and the forecast trigger module 426 to, for example, access information for the generation of time sheets and forecasts. The registration and authorization module 414 may identify, authorize, and register a user to access the services of the TEAM applications 224 and the forecast generation module 422.

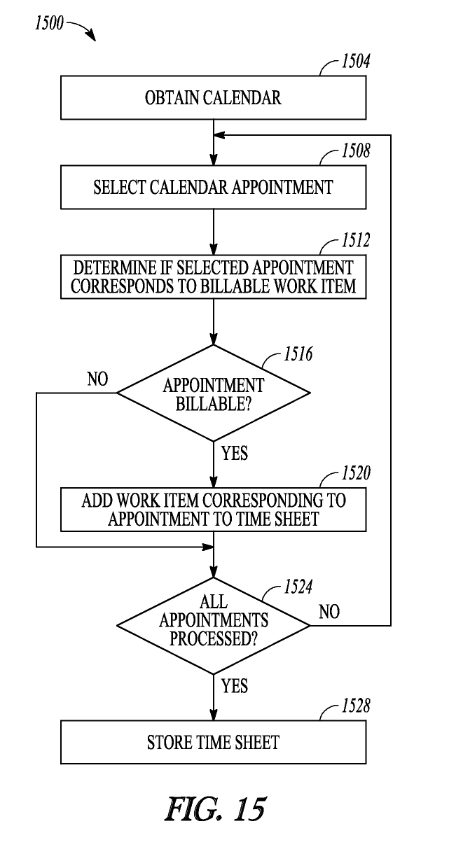

The time sheet generation module 418 may access a user's online calendar to generate a time sheet, as described more fully below in conjunction with FIG. 15. In addition, the time sheet generation module 418 may enable a user to modify and/or approve a generated time sheet.

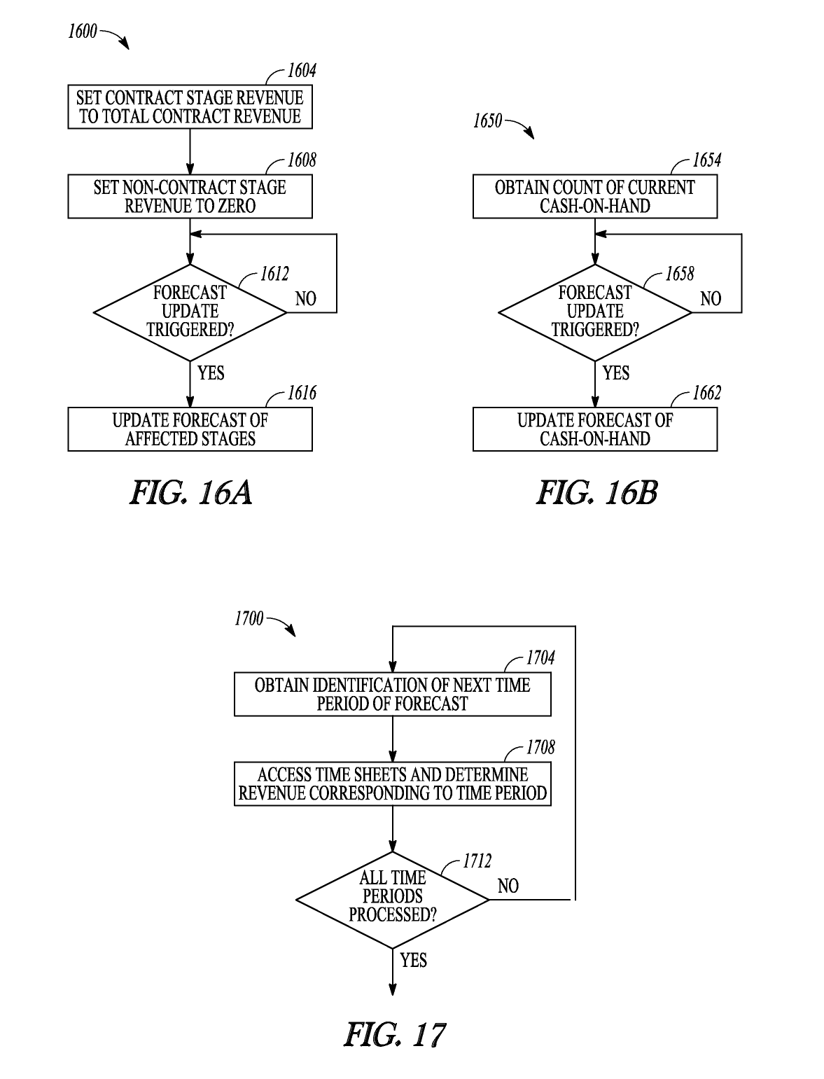

The forecast generation module 422 may utilize the information generated by the time sheet generation module 418 and the TEAM applications 224 to generate a business forecast, as described more fully below in conjunction with FIGS. 16A, 16B, and 17. For example, a revenue forecast (e.g., FIG. 16A), a cash-on-hand forecast (e.g., FIG. 16B), and/or a forecast based on processing scheduled events (e.g., FIG. 17) may be generated.

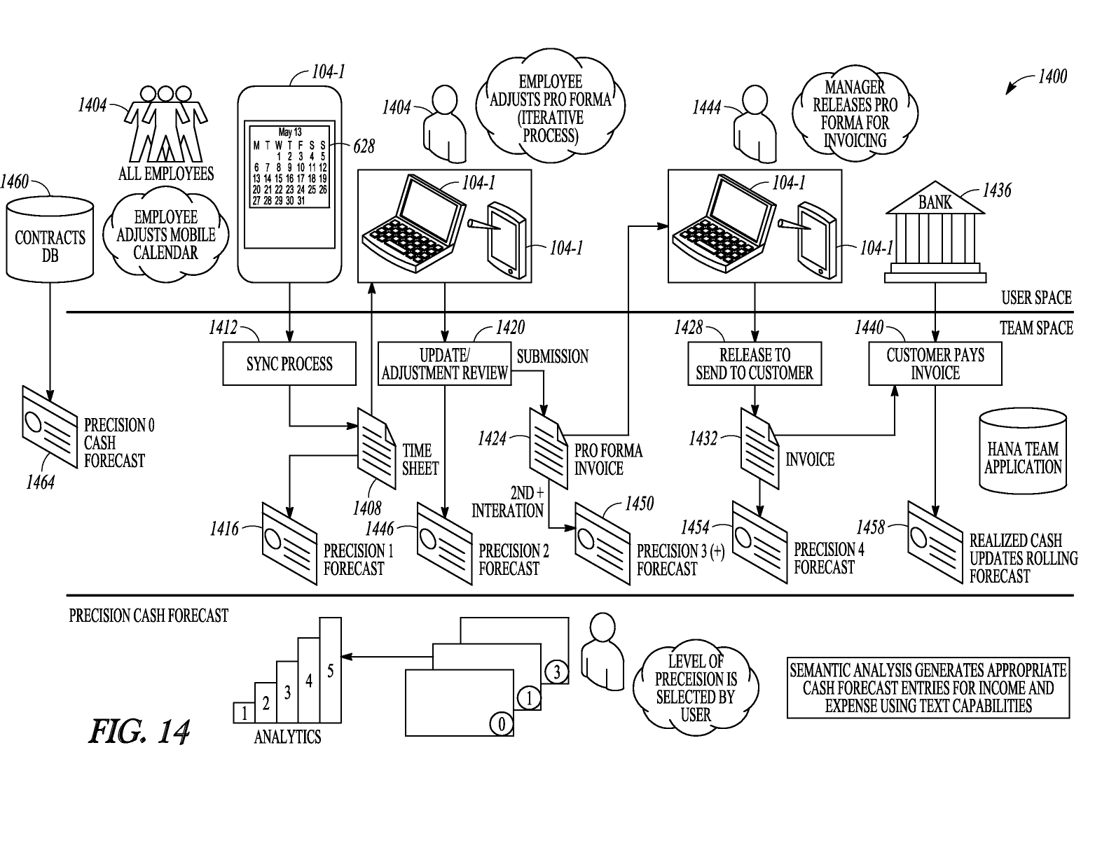

The forecast trigger module 426 may monitor events, including events occurring in the TEAM applications 224, and may generate one or more triggers to generate and/or update one or more forecasts, as described more fully below in conjunction with FIG. 14. The forecasts may be generated by the forecast generation module 422.

The storage interface module 430 may provide access to various storage elements, such as a database of business contracts, as described more fully below in conjunction with FIG. 14.

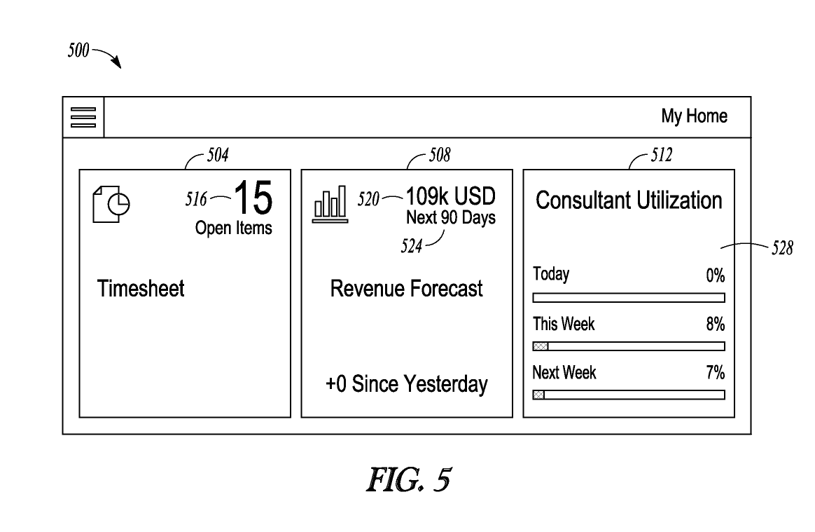

FIG. 5 is a representation of an example user interface 500 for a user home page, in accordance with an example embodiment. From the user home page, a user may access, for example, time sheets via a time sheet icon 504, a revenue forecast via a revenue forecast icon 508, and a utilization status and forecast via a utilization icon 512. The time sheet icon 504 may display, for example, a count 516 of open time sheet items; the revenue forecast icon 508 may display, for example, a revenue forecast 520 for a defined time period 524; and the utilization icon 512 may display, for example, a user's (e.g., a consultant's) utilization 528 for one or more defined time periods.

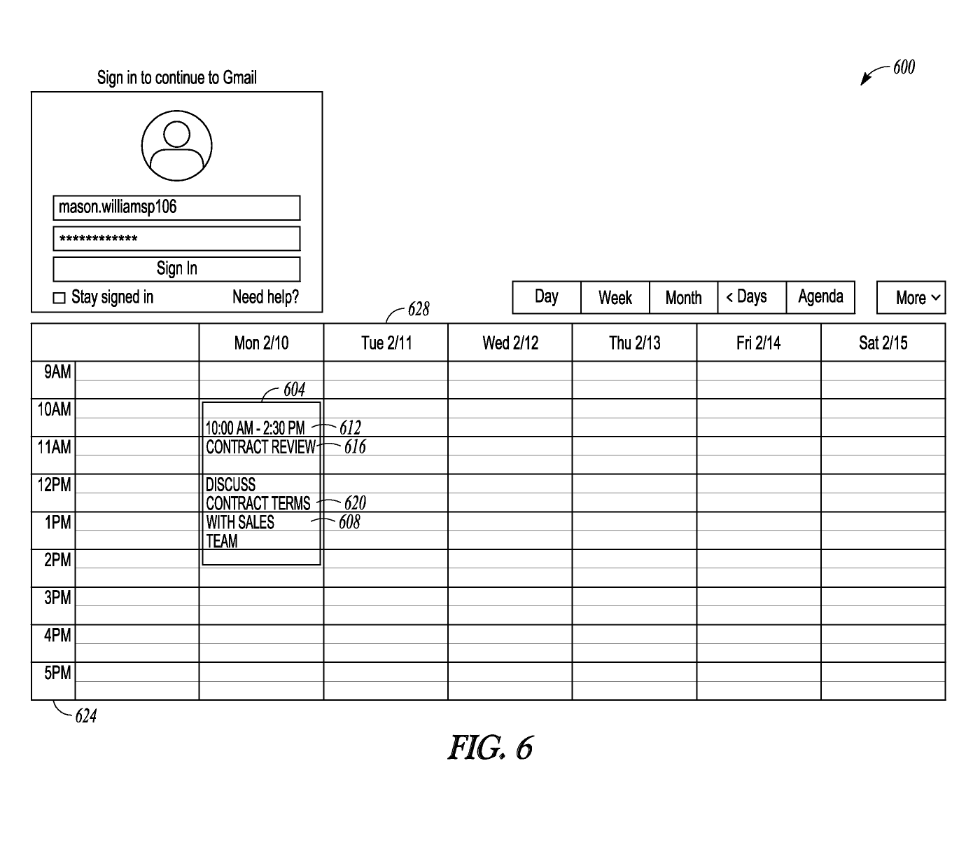

FIG. 6 is a representation of an example user interface 600 for scheduling appointments in an online calendar 628, in accordance with an example embodiment. A user may enter an appointment, such as appointment 604, comprising a description 608 of the appointment 604. For example, the description 608 may include the time period 612 for the appointment 604, a text description 616 of a subject of a meeting, and a text description 620 of work to perform. A location of the appointment 604 in the online calendar 628 may align with a time bar 624 to visually indicate the time period of the appointment 604.

FIG. 7 is a representation of an example user interface 700 for accessing a time sheet 704, in accordance with an example embodiment. The time sheet 704 may be used to log a number of hours worked for accounting purposes. In one example embodiment, the time sheet 704 may comprise a date 708 and time 712 for the hours worked, and a title 716 for the work. The user may enter the number of hours worked 720, a customer name or client code 724, and a project name 728.

In one example embodiment, the appointment 604 may be processed and a corresponding time sheet 704 may be automatically generated. For example, the date 708, the time 712, the title 716, the customer name or client code 724, and the project name 728 may be obtained from the appointment 604. In addition, the number of hours worked 720 may be determined from the appointment 604 by processing the time 712 and/or analyzing the location of the appointment 604 in relation to the time bar 624. In one example embodiment, the information cited above may be extracted from the appointment 604 and may be used to generate a forecast, but may not used to generate a time sheet 704. In one example embodiment, information cited above may be extracted from the appointment 604 and may be used to generate a forecast and a time sheet 704.

FIG. 8 is a representation of an example user interface 800 for modifying the time sheet 704, in accordance with an example embodiment. In one example embodiment, a user can modify the time sheet 704. For example, if a time sheet 704 is automatically generated from an appointment 604, and the corresponding work event lasted less time or more time than scheduled, a user may manually enter the correct time period into the time sheet 704. As illustrated in FIG. 8, a drop-down window may be accessed to modify the “hours worked” entry. The other elements of the time sheet 704 may also be modified.

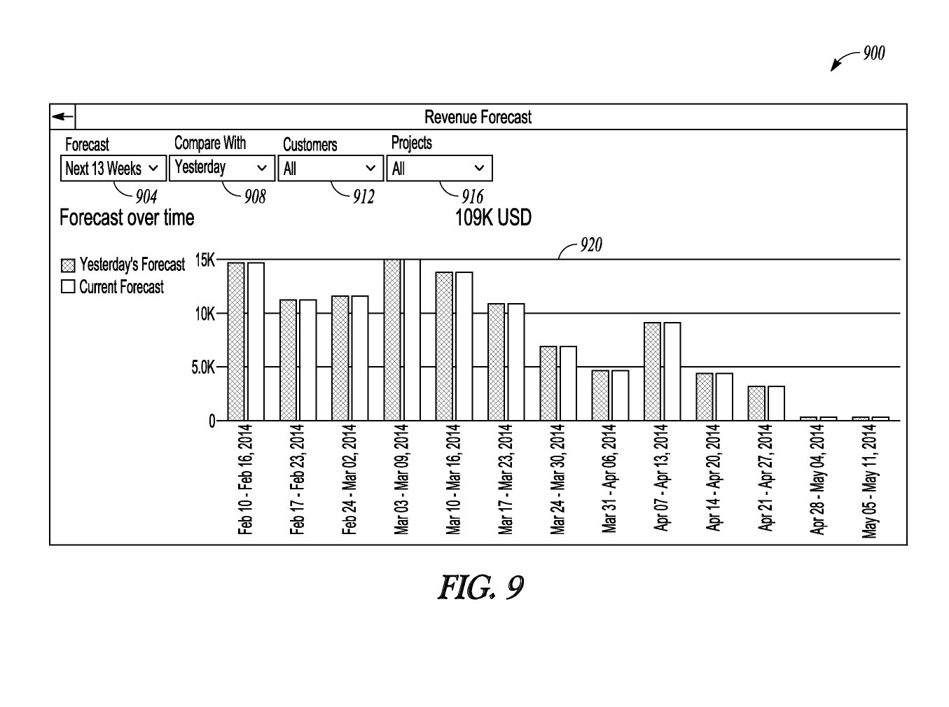

FIG. 9 is a representation of an example user interface 900 for viewing a revenue forecast, in accordance with an example embodiment. As illustrated in FIG. 9, a user may select a time period 904 for the forecast, a time period 908 for a comparison forecast, a set of one or more customers 912, and a set of one or more projects 916. The resulting forecast may be displayed in a variety of formats. In one example embodiment, the revenue forecast for each week of the selected forecast and the comparison forecast may be displayed as numeric values. As illustrated in FIG. 9, the revenue forecast for each week of the selected forecast and the comparison forecast may be displayed as a series of bar graphs 920. Each bar corresponds to the revenue forecast for a week of either the selected forecast or the comparison forecast. For example, for the week of March 3 through Mar. 9, 2014, the bars indicate that the revenue was 15K for both the selected (i.e., current) forecast and for the comparison forecast.

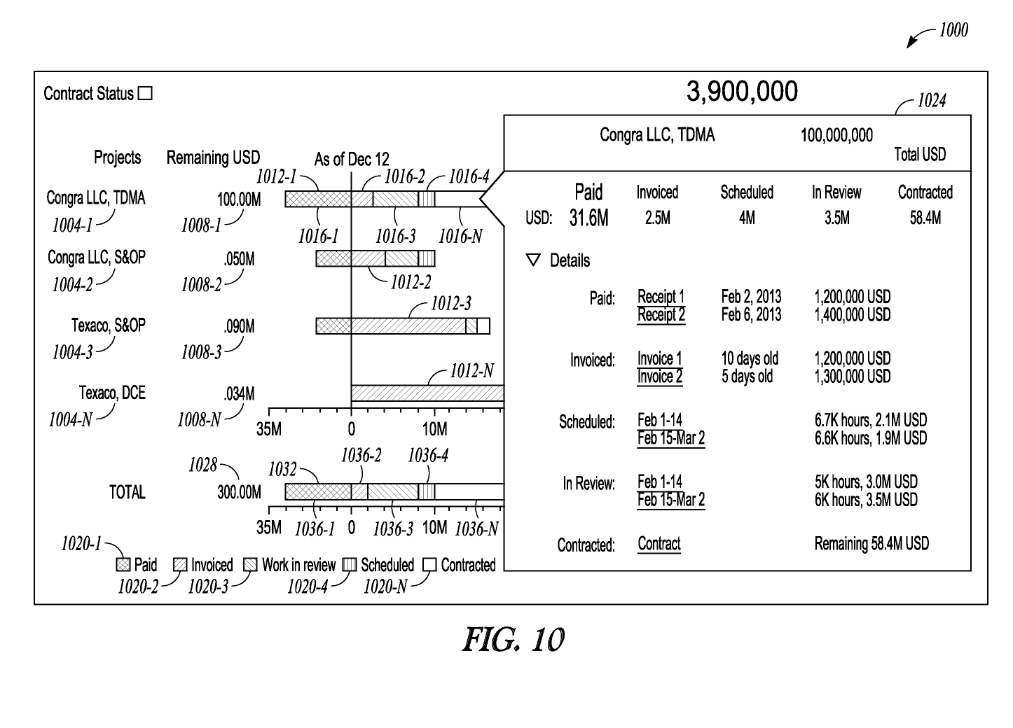

FIG. 10 is a representation of an example user interface 1000 for accessing a contract status, in accordance with an example embodiment. As illustrated in FIG. 10, each project 1004-1, . . . , 1004-N (hereinafter projects 1004) of the selected contract are displayed with a corresponding remaining budget 1008-1, . . . , 1008-N (hereinafter remaining budgets 1008) and contract burndown bar 1012-1, . . . , 1012-N (hereinafter contract burndown bars 1012). Each contract burndown bar 1012 comprises a contract burndown bar segment 1016-1, . . . , 1016-N (hereinafter contract burndown bar segments 1016) for each of a plurality of contract stages 1020-1, . . . , 1020-N (hereinafter contract stages 1020), where a length of each contract burndown bar segment 1016 is proportional to an amount of cash associated with the corresponding contract stage 1020. For example, the contract burndown bar segment 1016-1 indicates that $31.6 M has been paid, the contract burndown bar segment 1016-2 indicates that $2.5 M has been invoiced, the contract burndown bar segment 1016-3 indicates that $4.0 M has been scheduled, the contract burndown bar segment 1016-4 indicates that $3.5 M is in review, and the contract burndown bar segment 1016-N indicates that $58.4 M remains in the contract. A pop-up window 1024 provides the details of the contract status for the Congra LLC, TDMA project 1004-1. In one example embodiment, a total contract revenue 1028 for all applicable projects 1004-1-1004-N is provided and a corresponding contract burndown bar 1032 comprises a contract burndown bar segment 1036-1, . . . , 1036-N (hereinafter contract burndown bar segments 1036) for each of the plurality of contract stages 1020.

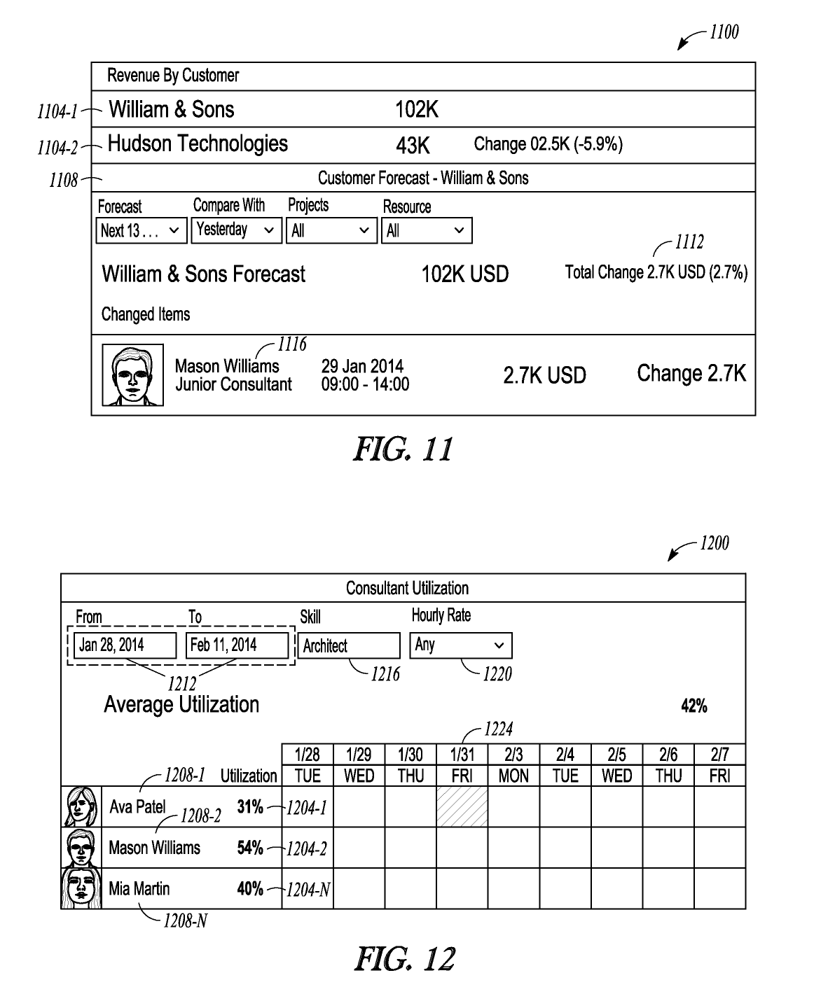

FIG. 11 is a representation of an example user interface 1100 for accessing details of a revenue forecast, in accordance with an example embodiment. As illustrated in FIG. 11, a revenue forecast may be displayed for each customer 1104-1 and 1104-2 (hereinafter customers 1104). In addition, the details of the changes to the revenue forecast for a particular customer, such as William and Sons 1104-1, may be displayed in window 1108. As indicated in window 1108, a total change 1112 of $2.7 K (2.7%) was incurred due to a change in revenue for Junior Consultant Mason Williams 1116.

FIG. 12 is a representation of an example user interface 1200 for accessing details of a utilization 1204-, . . . , 1204-N (hereinafter utilizations 1204) for a plurality of consultants 1208-1, . . . 1208-N (hereinafter consultants 1208), in accordance with an example embodiment. As illustrated in FIG. 12, a search for consultants of a specified skill type 1216 and specified hourly rate 1220 may be performed. In addition, the utilizations 1204 may be calculated for a specified time period 1212. In one example embodiment, a utilization for each consultant 1208 may be calculated for each day of the specified time period 1212 and the result may be indicated by a calendar 1224. The calendar 1224 may be color-coded where each color may represent a utilization range for the corresponding consultant 1208 on the corresponding day. For example, red (shown as a cross-hatch in FIG. 12) may indicate that the utilization 1204-1 is in the range of 30-39%.

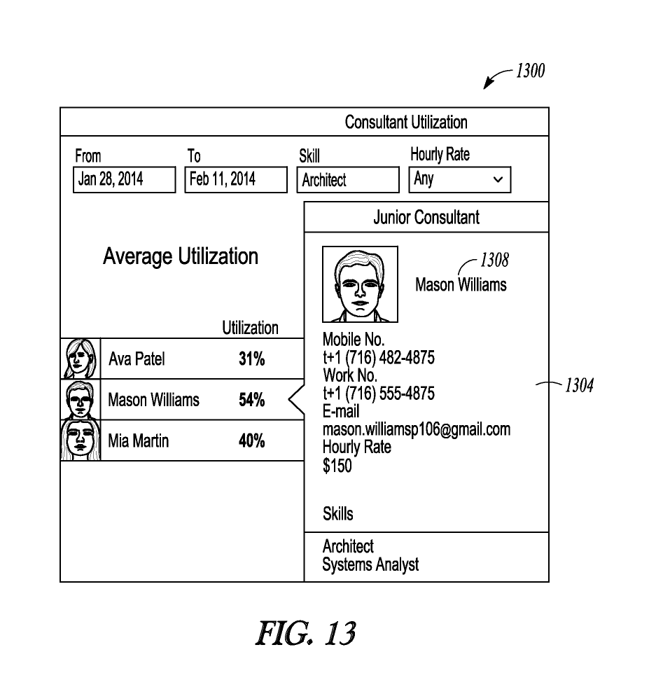

FIG. 13 is a representation 1300 of the example user interface 1200 of FIG. 12 overlaid with a consultant pop-up window 1304, in accordance with an example embodiment. As illustrated in FIG. 13, details of consultant 1208-2 may be viewed in consultant pop-up window 1304. For example, the name 1308, telephone number(s), email address, hourly rate, and skills for consultant 1208-2 may be displayed in consultant pop-up window 1304.

FIG. 14 is a flowchart for an example workflow 1400 for generating a business forecast, in accordance with an example embodiment. In one example embodiment, a contracts database 1460 containing one or more contracts may be maintained in the cloud infrastructure 216. A precision level 0 revenue forecast 1464 may be generated by accessing contracts in the contracts database 1460 and summing the revenue value of each contract covered by the forecast.

In one example embodiment, a user 1404 may utilize a client device 104-1 to, for example, schedule an appointment 604 on an online calendar 628. Each appointment 604 may be processed to generate a pro forma time sheet 1408 using, for example, a sync process, as described more fully below in conjunction with FIG. 15 (operation 1412). The generation of the pro forma time sheet 1408 may be performed dynamically at a time of entry of the appointment 604, at a later time, or in a batch mode with other appointments (operation 1412). As illustrated in FIG. 14, the generation of the pro forma time sheet 1408 may represent a low precision forecast. For example, the generation of the pro forma time sheet 1408 may be used to generate a precision level 1 revenue forecast 1416.

In one example embodiment, the user 1404 may utilize the client device 104-1 to review and, optionally, modify the pro forma time sheet 1408 (operation 1420). The review and optional modification of the pro forma time sheet 1408 may be performed once or may be performed iteratively. In one example embodiment, a user may review and modify the pro forma time sheet 1408 on behalf of the user 1404. The review and optional modification of the pro forma time sheet 1408 may generate a reviewed pro forma time sheet (not shown). As illustrated in FIG. 14, the reviewed pro forma time sheet may be used to generate a higher-level precision forecast. For example, the generation of the reviewed pro forma time sheet may be used to generate a precision level 2 revenue forecast 1446.

In one example embodiment, a pro forma invoice 1424 may be generated as part of operation 1420. As illustrated in FIG. 14, the pro forma invoice 1424 may be used to generate a higher-level precision forecast. For example, the generation of the pro forma invoice 1424 may be used to generate a precision level 3 revenue forecast 1450.

In one example embodiment, a user 1444 may utilize a client device 104-1 to review and, optionally, modify the reviewed pro forma time sheet and/or the pro forma invoice 1424 to generate an approved invoice 1432 for the approved reviewed pro forma time sheet (operation 1428). In one example embodiment, before the invoice is generated from the pro forma time sheet, a validation of the amounts to be invoiced may be performed to ensure that the agreement defined in the contract is not violated. For example, the pro forma may include travel expenses that must adhere to an agreed maximum claim for expenses or number of hours that may be billed in a month (as defined in the contract). A manual review and approve cycle may be used to ensure that the contract constraints are not violated. For example, if the maximum number of hours billable in a particular month reaches a particular limit, then the reviewer may be notified that the recorded billable hours have been reduced due to the billing cap.

The approved invoice 1432 may be released to a customer. In one example embodiment, the invoice for the approved pro forma time sheet may be added to an existing invoice or may be queued for the generation of an invoice at a later time. As illustrated in FIG. 14, the generation of the approved invoice 1432 may be used to generate a higher-level precision forecast. For example, the generation of the approved invoice 1432 may be used to generate a precision level 4 revenue forecast 1454.

In one example embodiment, a client of a business may receive the approved invoice 1432 and may make a payment to the business via, for example, a bank 1436 (operation 1440). The receipt of the payment by the business may result in updating the forecast with the received payment and may be used to generate a highest-level precision forecast 1458.

In one example embodiment, the forecast trigger module 426 may generate one or more triggers that initiate a generation or updating of one or more corresponding forecasts. In one example embodiment, the forecast trigger module 426 may receive events generated by various workflows, such as workflow 1400, and events generated by various periodic timers (e.g., a daily timer, a weekly timer, and a monthly timer). The forecast trigger module 426 may generate one or more triggers based on the received events. Example triggers may include a signing of a contract, a scheduling of a calendar event, a completion of a work item, an approval of a time sheet 704, a generation of an invoice (operation 1428), a receipt of payment (operation 1440), a submission of a purchase order, an approval of a purchase order, and a payment of a contractor.

For example, an approval of a time sheet 704 may trigger the updating of a revenue forecast. In one example embodiment, a trigger may initiate an updating of all components of a forecast, such as all contract stages 1020. In one example embodiment, a trigger may initiate an updating of only the components of a forecast that are affected by the corresponding event. For example, a generation of an invoice may trigger the updating of an accounting of invoices and an accounting of scheduled revenue.

FIG. 15 is a flowchart for an example method 1500 for generating a time sheet 704 from calendar entries, in accordance with an example embodiment. The operations of the example method 1500 may be performed by the time sheet generation module 418 as part of the sync process 1412.

In one example embodiment, an online calendar 628 of a selected user may be obtained or accessed (operation 1504). For example, a calendar for consultant 1208-2 may be accessed. An appointment 604 may be selected (operation 1508) and processed to determine if the selected appointment 604 corresponds to a billable work item and is to be logged as an entry in the time sheet 704 (operation 1512). For example, the description of the appointment 604, such as the title 716, the customer name or client code 724, and/or the project name 728, may be processed to determine if any of the cited entities correspond to a valid project or work item that is to be invoiced to a customer. In one example embodiment, a fuzzy search may be conducted to determine if the work item of the appointment 604 sufficiently matches a valid project or work item that is to be invoiced. A test may be performed to determine if the appointment is billable (operation 1516). If the appointment 604 is billable (for example, the description of the appointment 604 sufficiently matches a valid project or work item that is to be invoiced), a work item corresponding to the appointment 604 is added to the time sheet (operation 1520). For example, the time period 612 and, optionally, the customer name or client code 724 and/or project name 728 may be extracted from the appointment 604 and the extracted information may then be entered in the time sheet 704 corresponding to the specified time period 612.

If the appointment 604 is not billable (for example, the description of the appointment 604 does not sufficiently match a valid project or work item that is to be invoiced), a test may be performed to determine if all appointments 604 have been processed (operation 1524). If another appointment 604 is available for processing, the method may proceed with operation 1508 and a next appointment 604 may be accessed. If another appointment 604 is not available for processing, the time sheet 704 may be saved (operation 1528) and the method 1500 may end.

FIG. 16A is a flowchart for an example method 1600 for generating a forecast, in accordance with an example embodiment. The operations of the example method 1600 may be performed by the forecast generation module 422.

In one example embodiment, a forecast of revenue for each day in the projected life of a contract may be generated. As described above, a status of a contract may be segmented into a plurality of contract stages 1020 where a portion of the revenue of the contract may be assigned to each stage. For example, upon signing, the contract may indicate the total projected revenue of $100 M. All of the projected revenue may initially correspond to a first stage, such as a “contracted” stage. As work on the contract progresses, various work items may be scheduled, reviewed, invoiced, and paid. The revenue associated with each item may be assigned to the corresponding contract stage 1020. As the work progresses, the revenue of the contracted stage may continue to decrease and the revenue of the paid stage may continue to increase. Once the contract is complete, the paid stage should have a revenue amount substantially equal to the initial revenue of the contracted stage. The remaining stages should have substantially zero revenue once the contract is completed. Exceptions may occur, for example, in situations where a customer fails to pay an invoice or a worker fails to submit a time sheet.

In one example embodiment, an amount of revenue corresponding to a contract stage 1020 may be initialized to the total revenue indicated in the contract (operation 1604) and the revenue of the remaining stages is set to zero (operation 1608). A test may be performed to determine if a forecast update has been triggered (operation 1612). For example, a timer may expire indicating that a periodic forecast update should be performed or an event may occur, such as approval of a time sheet 704, indicating that a forecast update should be performed. If a triggering event has not occurred, the method may repeat operation 1612; otherwise, the forecast may be updated (operation 1616).

During operation 1616, the update of the forecast may be performed and the revenue associated with each contract stage may be updated. The update of the forecast may be performed in a variety of ways. In one example embodiment, the update to a forecast is restricted to updating only the contract stages 1020 affected by an event. For example, the scheduling of an appointment 604 may result in only the contracted stage and the scheduled stage being updated. In this example, the revenue associated with the appointment 604 may be determined by, for example, multiplying the hourly rate of an employee by the amount of time scheduled for the appointment 604 and the cited revenue may be subtracted from the contracted stage and added to the scheduled stage.

In one example embodiment, the revenue for each stage may be recalculated. For example, a database of pending invoices may be scanned and a sum of the revenue for the pending invoices may be generated and assigned to the invoiced stage 1020-2, where a pending invoice is an invoice that has been at least partially generated but has not been paid. Similarly, a database of paid invoices may be scanned and a sum of the revenue for the paid invoices may be generated and assigned to the paid stage 1020-N.

FIG. 16B is a flowchart for an example method 1650 for generating a forecast, in accordance with an example embodiment. In one example embodiment, a forecast of cash-on-hand for each day is generated. The operations of the example method 1650 may be performed by the forecast generation module 422.

In one example embodiment, an amount of cash-on-hand corresponding to an initial date of the forecast is obtained (operation 1654).

A test may be performed to determine if a forecast update has been triggered (operation 1658). For example, a timer may expire indicating that a periodic forecast update should be performed or an event may occur, such as receipt of payment from a client or a payment to a contractor, indicating that a forecast update should be performed. If a triggering event has not occurred, the method may repeat operation 1658; otherwise, the forecast may be updated (operation 1662).

The update of the cash-in-hand forecast may be performed in a variety of ways. In one example embodiment, the update to the forecast is restricted to only the inflow or outflow of cash related to the event that triggered the forecast update. In one example embodiment, a scheduled event may indicate that a company's payroll is disbursed and the dollar amount of the payroll may be subtracted from the present cash-in-hand. In one example embodiment, an approval of a purchase order may result in a reduction in the projected cash-in-hand. The projection may be determined by summing the typical number of days to issue the purchase order (e.g., three days) and the number of days permitted for making payment (e.g., 30 days), and reducing the projection of the cash-in-hand by the purchase amount at a date 33 days in the future.

Similar updates may be performed for fixed expenses (e.g., rent, and maintenance contracts), periodic expenses (e.g., salaries, employee bonuses, and taxes), periodic revenues (e.g., interest and the like), and variable revenue (e.g., billable hours, and sold goods).

FIG. 17 is a flowchart for an example method 1700 for generating a forecast, in accordance with an example embodiment. In one example embodiment, a forecast of revenue for each day in the projected life of a contract or for specified time periods may be generated. The operations of the example method 1700 may be performed by the forecast generation module 422.

In one example embodiment, an identification of a time period of the forecast may be obtained (operation 1704). The pro forma time sheets 1408 corresponding to the obtained time period may be accessed and a determination made as to the revenue associated with the time sheets 704 (operation 1708). The determination may be made by multiplying the number of hours recorded in each time sheet 704 by the hourly rate of the associated employee. The determined revenues may then be summed to generate the forecast revenue for the time period.

A test may be performed to determine if all time periods have been processed (operation 1712). If all time periods have been processed, the method 1700 may end; otherwise, the next time period may be obtained (operation 1704) and the method 1700 may proceed with operation 1708.

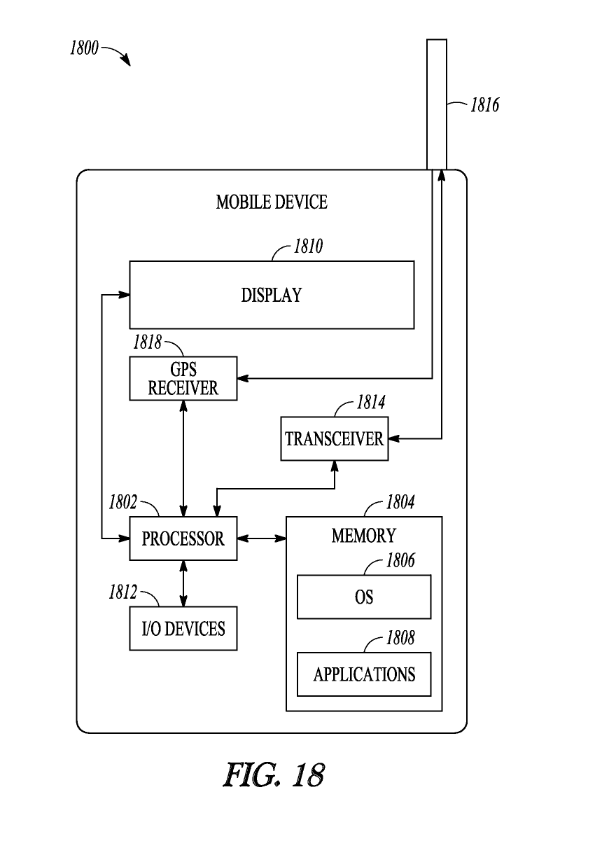

FIG. 18 is a block diagram illustrating an example mobile device 1800, according to an example embodiment. The mobile device 1800 can include a processor 1802. The processor 1802 can be any of a variety of different types of commercially available processors suitable for mobile devices 1800 (for example, an XScale architecture microprocessor, a Microprocessor without Interlocked Pipeline Stages (MIPS) architecture processor, or another type of processor). A memory 1804, such as a random access memory (RAM), a Flash memory, or other type of memory, is typically accessible to the processor 1802. The memory 1804 can be adapted to store an operating system (OS) 1806, as well as application programs 1808, such as a mobile location enabled application that can provide LBSs to a user. The processor 1802 can be coupled, either directly or via appropriate intermediary hardware, to a display 1810 and to one or more input/output (I/O) devices 1812, such as a keypad, a touch panel sensor, and a microphone. Similarly, in some embodiments, the processor 1802 can be coupled to a transceiver 1814 that interfaces with an antenna 1816. The transceiver 1814 can be configured to both transmit and receive cellular network signals, wireless data signals, or other types of signals via the antenna 1816, depending on the nature of the mobile device 1800. Further, in some configurations, a GPS receiver 1818 can also make use of the antenna 1816 to receive GPS signals.

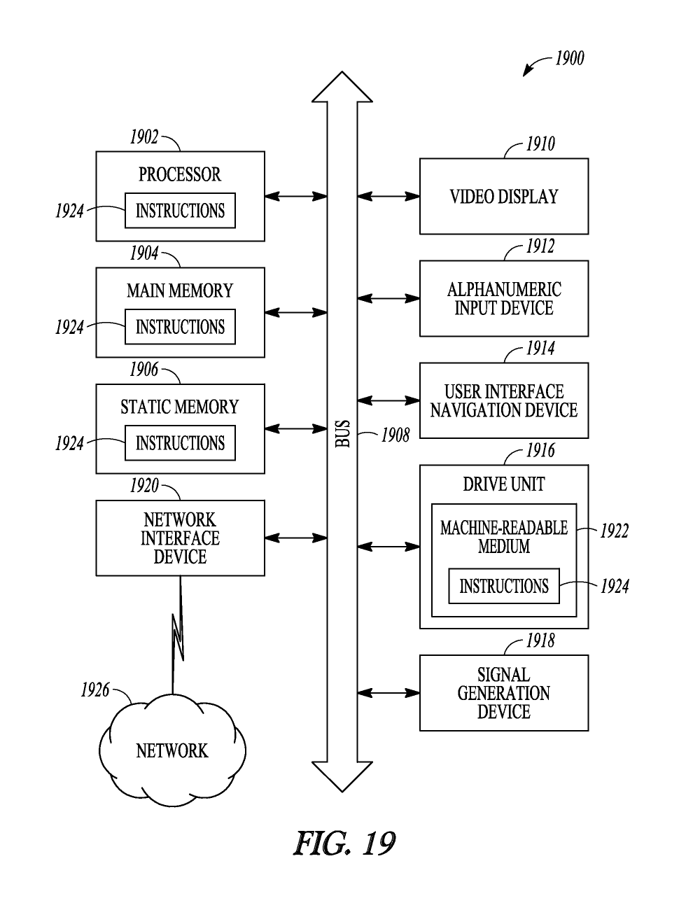

FIG. 19 is a block diagram of a computer processing system 1900 within which a set of instructions may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed by software-as-a-service (SaaS), application service provider (ASP), or by utility computing providers. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that, individually or jointly, execute a set (or multiple sets) of instructions to perform any one or more of the methodologies discussed herein.

The example computer processing system 1900 includes a processor 1902 (e.g., a central processing unit (CPU), a graphics processing unit (GPU) or both), a main memory 1904 and static memory 1906, which communicate with each other via a bus 1908. The computer processing system 1900 may further include a video display unit 1910 (e.g., a plasma display, a liquid crystal display (LCD) or a cathode ray tube (CRT)). The computer processing system 1900 also includes an alphanumeric input device 1912 (e.g., a keyboard), a user interface (UI) navigation device 1914 (e.g., a mouse and/or touch screen), a drive unit 1916, a signal generation device 1918 (e.g., a speaker), and a network interface device 1920.

The drive unit 1916 includes machine-readable medium 1922 on which is stored one or more sets of instructions 1924 and data structures embodying or utilized by any one or more of the methodologies or functions described herein. The instructions 1924 may also reside, completely or at least partially, within the main memory 1904, static memory 1906, and/or within the processor 1902 during execution thereof by the computer processing system 1900, the main memory 1904, static memory 1906, and the processor 1902 also constituting tangible machine-readable media 1922.

The instructions 1924 may further be transmitted or received over network 1926 via a network interface device 1920 utilizing any one of a number of well-known transfer protocols (e.g., Hypertext Transfer Protocol).

While the machine-readable medium 1922 is shown in an example embodiment to be a single medium, the term “machine-readable medium” should be taken to include a single medium or multiple media (e.g., a centralized or distributed database, and/or associated caches and servers) that store the one or more sets of instructions 1924. The term “machine-readable medium” shall also be taken to include any medium that is capable of storing, encoding or carrying a set of instructions 1924 for execution by the computer and that cause the computer to perform any one or more of the methodologies of the present application, or that is capable of storing, encoding or carrying data structures utilized by or associated with such a set of instructions 1924. The term “machine-readable medium” shall accordingly be taken to include, but not be limited to, solid-state memories, and optical and magnetic media.

While the embodiments of the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for generating a data forecast, the method comprising:
obtaining a specification of a precision level of a forecast;
identifying data that satisfies the specified precision level of the forecast; and
generating a forecast based on the identified data that satisfies the specified precision level of the forecast.

2. The computerized method of claim 1, further comprising generating one or more of a time sheet and an invoice from one or more calendar entries of a user and wherein the forecast is based on one or more of the generated time sheet and the generated invoice.

3. The computerized method of claim 2, further comprising generating a sum of billable hours for the generated invoice.

4. The computerized method of claim 1, wherein the generated forecast corresponds to a specified time period.

5. The computerized method of claim 1, wherein data that fails to satisfy the specified precision level of the forecast is excluded from use in the generation of the forecast.

6. The computerized method of claim 1, wherein the generation of the forecast is triggered by one or more of a calendar event, a generation of an invoice, a scheduled time, an expiration of a timer, a signing of a contract, a completion of a work item, an approval of a time sheet, a receipt of a payment, a submission of a purchase order, an approval of a purchase order, and a payment of a contractor.

7. The computerized method of claim 1, wherein the forecast is a revenue forecast based on one or more of: one or more calendar entries of one or more users, one or more approved time sheets, one or more approved invoices, and one or more receipts of payment.

8. The computerized method of claim 1, wherein the forecast is a cash-on-hand forecast based on one or more of: a projected receipt of payments, a revenue forecast, and a projection of interest received.

9. The computerized method of claim 1, wherein the forecast is an expense forecast based on one or more of: one or more employee salaries, one or more contractors payments, one or more employee expenses, and one or more fixed expenses.

10. The computerized method of claim 1, further comprising maintaining an accounting for each of a plurality of stages of a contract and wherein the forecast is based on the maintained accounting.

11. The computerized method of claim 10, wherein the plurality of stages includes a contract stage, a scheduled stage, a review stage, an invoice stage, and a paid stage.

12. The computerized method of claim 1, further comprising maintaining an account for each of one or more of: scheduled billable hours, issued invoices, paid invoices, and projected payment receipts.

13. The computerized method of claim 1, further comprising tracking one or more of client behavior, approver behavior, and seller delivery behavior, wherein the forecasting is based on one or more of the tracked client behavior, the tracked approver behavior, and the tracked seller delivery behavior.

14. An apparatus for generating a data forecast, the apparatus comprising:
a processor;
memory to store instructions that, when executed by the processor, cause the processor to:
obtain a specification of a precision level of a forecast;
identify data that satisfies the specified precision level of the forecast; and
generate a forecast based on the identified data that satisfies the specified precision level of the forecast.

15. The apparatus of claim 14, further comprising instructions that, when executed by the processor, cause the processor to generate one or more of a time sheet and an invoice from one or more calendar entries of a user, wherein the forecast is based on one or more of the generated time sheet and the generated invoice.

16. The apparatus of claim 14, wherein data that fails to satisfy the specified precision level of the forecast is excluded from use in the generation of the forecast.

17. The apparatus of claim 14, further comprising instructions that, when executed by the processor, cause the processor to maintain an accounting for each of a plurality of stages of a contract and wherein the forecast is based on the maintained accounting.

18. The apparatus of claim 14, wherein the plurality of stages includes a contract stage, a scheduled stage, a review stage, an invoice stage, and a paid stage.

19. An apparatus for generating a data forecast, the apparatus comprising:
a forecast interface module for obtaining a specification of a precision level of a forecast; and
a forecast processing module for identifying data that satisfies the specified precision level of the forecast and generating a forecast based on the identified data that satisfies the specified precision level of the forecast.

20. A non-transitory machine-readable storage medium comprising instructions that, when executed by one or more processors of a machine, cause the machine to perform operations comprising:
obtaining a specification of a precision level of a forecast;
identifying data that satisfies the specified precision level of the forecast; and
generating a forecast based on the identified data that satisfies the specified precision level of the forecast.
